(19) United States
(12) Patent Application Publication
(10) Pub. No.: US 2007/0210965 A1
(43) Pub. Date: Sep. 13, 2007

(54) Planar Antenna

(76) Inventors: Yoshinao Takada, Tokyo (JP); Daisuke Nozue, Kanagawa (JP)

Correspondence Address: BARLEY SNYDER, LLC, 1000 WESTLAKES DRIVE, SUITE 275, BERWYN, PA, 19312, US

(21) Appl. No.: 11/683,591

(22) Filed: Mar. 8, 2007

(30) Foreign Application Priority Data
Mar. 10, 2006 (JP) 2006-066602

(51) Int. Cl. H01Q 1/38

(52) U.S. Cl. 343/700 MS; 343/846

(57) ABSTRACT

A planar antenna includes a ground plane having a ground point. A main radiating element has a feeding point positioned adjacent to the ground point. The main radiating element is positioned adjacent to a contact side of the ground plane such that a space is formed there between. A parasitic element is positioned adjacent to the contact side such that a space is formed there between. The main radiating element has a shape such that the space between the main radiating element and the contact side becomes larger as the main radiating element becomes closer to the parasitic element and the parasitic element has a shape such that the space between the parasitic element and the contact side becomes larger as the parasitic element becomes closer to the main radiating element. Additionally, the parasitic element may have a slit formed therein.

### CROSS-REFERENCE TO RELATED APPLICATIONS

This application claims the benefit of the filing date under 35 U.S.C. §119(a)-(d) of Japanese Patent Application No. 2006-066602, filed Mar. 10, 2006.

### FIELD OF THE INVENTION

The present invention relates to a planar antenna formed within a single plane that comprises a ground plane, a main radiating element, and a parasitic element formed in a printed board.

### BACKGROUND

A communication method of transmitting and receiving signals in a wide frequency band has been recently used for radio communications. For example, a software radio technique processes signals including a base band signal up to an intermediate frequency signal by using a microprocessor, digital signal processing (DSP) or the like. The software radio technique switches multiple communication methods from one to another by rewriting software and thereby makes it possible to process signals in a wide frequency band. As signals are now transmitted in a wider frequency band, there is a need for antennas, which transmit and receive such signals, to broaden the frequency band. In response to this need, various antennas have been proposed. For example, a circular disc monopole antenna provided with a disc-shaped monopole element as a main radiating element is disclosed in Agrawall, “Wide-Band Planar Monopole Antennas,” IEEE Transactions on Antennas and Propagation, Vol. 46, No. 2 (February 1998). Moreover, Japanese Patent Application Laid-open Publication No. 2001-284946 discloses an antenna provided with a parasitic element in addition to the main radiating element. A planar antenna provided with the parasitic element is disclosed in Kumar, “Broad-Band Microstrip Antennas Using Additional Resonators Gap-Coupled to the Radiating Edges,” IEEE Transactions on Antennas and Propagation, Vol. AP-32, No. 12 (December 1984).

However, a ground plane is needed for the circular disc monopole antenna disclosed in Agrawall. The ground plane is disposed in a direction orthogonal to the disc-shaped monopole element. The height from the ground plane to the tip of the monopole element needs to be approximately one fourth of a free-space wavelength at the minimum operating frequency. For this reason, the installation of such a circular disc monopole antenna needs a large space. Additionally, in each of the antennas disclosed in Kumar and in Japanese Patent Application Laid-open Publication No. 2001-284946, a parasitic element corresponds to a single electrical resonating point. Consequently, a large number of parasitic elements need to be provided in order to broaden the frequency band. Thus, it is difficult to miniaturize these antennas.

### BRIEF SUMMARY

A planar antenna comprises a ground plane having a ground point. A main radiating element has a feeding point positioned adjacent to the ground point. The main radiating element is positioned adjacent to a contact side of the ground plane such that a space is formed there between. A parasitic element is positioned adjacent to the contact side of the ground plane such that a space is formed there between. The parasitic element is connected to the ground plane at a position farthest from the main radiating element, and the parasitic element has at least one slit formed therein.

A planar antenna comprises a ground plane having a ground point. A main radiating element has a feeding point positioned adjacent to the ground point. The main radiating element is positioned adjacent to a contact side of the ground plane such that a space is formed there between. A parasitic element is positioned adjacent to the contact side of the ground plane such that a space is formed there between. The main radiating element has a shape such that the space between the main radiating element and the contact side of the ground plane becomes larger as the main radiating element becomes closer to the parasitic element and the parasitic element has a shape such that the space between the parasitic element and the contact side becomes larger as the parasitic element becomes closer to the main radiating element.

### BRIEF DESCRIPTION OF THE DRAWINGS

FIG. 1 is a plan view of a planar antenna according to an embodiment of the invention.

FIG. 2 is a plan view of a signal source connected to the planar antenna shown in FIG. 1.

FIG. 3 is a plan view of a planar antenna according to a comparative example.

FIG. 4 is a graph comparing the measuring properties of the planar antenna shown in FIG. 1 with the planar antenna shown in FIG. 3.

### DETAILED DESCRIPTION OF THE EMBODIMENT(S)

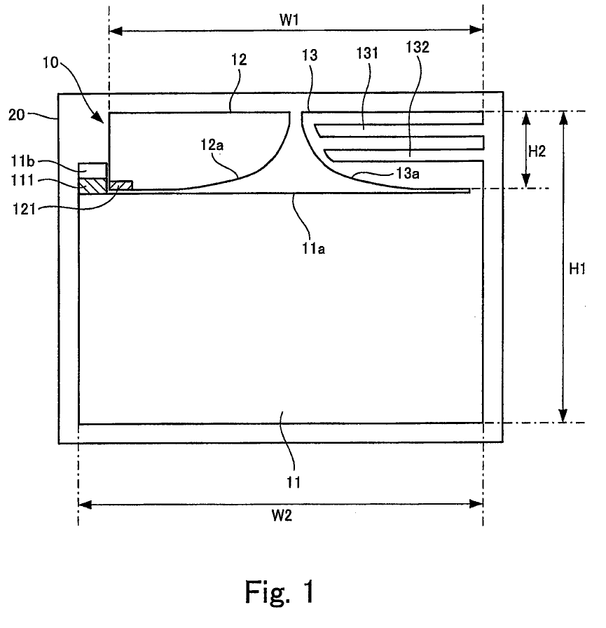

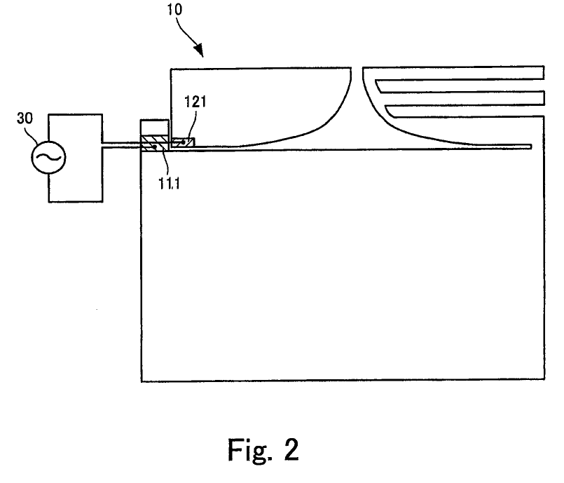

FIGS. 1-2 show a planar antenna 10 according to an embodiment of the invention. As shown in FIG. 1, the planar antenna comprises a printed-wiring pattern that may be formed, for example, in a surface of a printed board 20. The printed board 20 may be, for example, a flexible dielectric substrate, thereby enabling the planar antenna 10 to be disposed in spaces of various shapes by curving the planar antenna 10 or by bending a portion thereof. The planar antenna 10 is formed within a single plane on a single surface of the printed board 20 and has a substantially rectangular shape. The planar antenna 10 has a first area with a width W1 and a second area with a width W2, which is slightly wider than the width W1. The planar antenna 10 has a height H1. The planar antenna 10 includes a ground plane 11, a main radiating element 12, and a parasitic element 13 disposed near the main radiating element 12.

The ground plane 11 has a substantially rectangular shape consisting, for example, of four opposing sides and four corners. The ground plane 11 has a protruding section 11b formed on one of the corners of the ground plane 11 that overreaches the main radiating element 12 in a direction of width of the planar antenna 10 and substantially surrounds a feeding point 121 of the main radiating element 12. A ground point 111 is disposed on the protruding section 11b and is in contact with a contact side 11a of the ground plane 11. The contact side 11a is substantially straight. The ground point 111 is disposed in a position closest to the ground plane 11 of the main radiating element 12 and farthest from the parasitic element 13.

The main radiating element 12 has a substantial right-angled triangle shape with an arc shaped side 12a. The main radiating element 12 has a height H2. The main radiating element 12 is arranged in the first area with the width W1 and extends along and is spaced from the contact side 11a of the ground plane 11. The space between the main radiating element 12 and the contact side 11a becomes larger as the main radiating element 12 approaches the parasitic element 13 such that the main radiating element 12 is closest to the ground plane 11 in a position where the main radiating element 12 is farthest from the parasitic element 13. The arc shaped side 12a of the main radiating element 12 is placed such that the arc shaped side 12a faces the contact side 11a of the ground plane 11 and the parasitic element 13. A feeding point 121 is arranged in a corner of the main radiating element proximate the ground point 111 of the ground plane 11.

The parasitic element 13 has a substantial right-angled triangle shape with an arc shaped side 13a. The parasitic element 13 has the height H2. The parasitic element 13 is arranged in the first area with the width W1 and extends along and is spaced from the contact side 11a of the ground plane 11. The space between the parasitic element 13 and the contact side 11a becomes larger as the parasitic element 13 approaches the main radiating element 12 such that the parasitic element 13 is closest to the contact side 11a in a position where the parasitic element 13 is farthest from the main radiating element 12. The arc shaped side 13a of the parasitic element 13 is placed such that the arc shaped side 13a of the parasitic element 13 faces the contact side 11a of the ground plane 11 and the main radiating element 12. Substantially straight slits 131, 132 are formed in the parasitic element 13. The slits 131, 132 extend substantially parallel to the contact side 11a of the ground plane 11 and have mutually different lengths.

The planar antenna 10 broadens a frequency area, because the shapes of the main radiating element 12 and the parasitic element 13 cause electrical resonance points to be dispersed in a certain range. The slits 131, 132 are used to further broaden the frequency area and are formed to have mutually different lengths so as to disperse the electrical resonance points of the planar antenna 10 in a wider range of frequencies. Additionally, because the slits 131, 132 extend substantially parallel to the contact side 11a of the ground plane 11, the planar antenna 10 efficiently broadens the frequency band. Extra electrical resonance points are thereby added by the slits 131, 132 without providing additional parasitic elements, which enables the size of the planar antenna 10 to be kept small while broadening the frequency band.

Although two of the slits 131, 132 are shown in the illustrated embodiment, it will be appreciated by those skilled in the art that the number of slits may be varied according to a desired frequency band. In addition, the lengths of the slits 131, 132 may be formed to be the same, because the slits 131, 132 have mutually different resonating points in accordance with the position where each of the slits 131, 132 is formed. However, by forming the slits 131, 132 to have mutually different lengths, the resonating points are dispersed in a wider range of frequencies, and thereby the planar antenna 10 further broadens the frequency band.

The first width W1 of the planar antenna 10, in which the main radiating element 12 and the parasitic element 13 are disposed side-by-side, has a dimension in a range of about one fourth to one third of the minimum operating frequency of the planar antenna 10. The height H2 of the main radiating element 12 and the parasitic element 13 is not more than about one tenth of the minimum operating frequency in order to ensure properties suitable for practical use. Because the second area with the width W2 is slightly wider than the width W1 of the first area where the main radiating element 12 and the parasitic element 13 are disposed, a shield of a coaxial cable can be easily connected to the planar antenna 10. Additionally, although the properties of the planar antenna 10 are more stabilized because the dimension of the height H1 of the planar antenna 10 including the ground plane 11 is longer, stable properties can also be obtained regardless of the dimension of the height H1 by electrically connecting the ground plane 11 with a metal portion of a casing of a device or the like.

The planar antenna 10 may be manufactured, for example, by removing unnecessary metal films from the printed board 20 that have been formed, for example, by superposing metal films such as copper thereon. The unnecessary metal films may be removed, for example, by an etching method or the like. Alternatively, the planar antenna 10 may be manufactured, for example, by bonding a metal sheet formed by a cutting process with the surface of the printed board 20. It will be appreciated by those skilled in the art that the planar antenna 10 may also be manufactured by other known methods. As shown in FIG. 2, the planar antenna 10 may be used, for example, as a transmission antenna wherein the ground point 111 and the feeding point 121 of the planar antenna 10 are connected to a signal source 30 via a coaxial cable or the like.

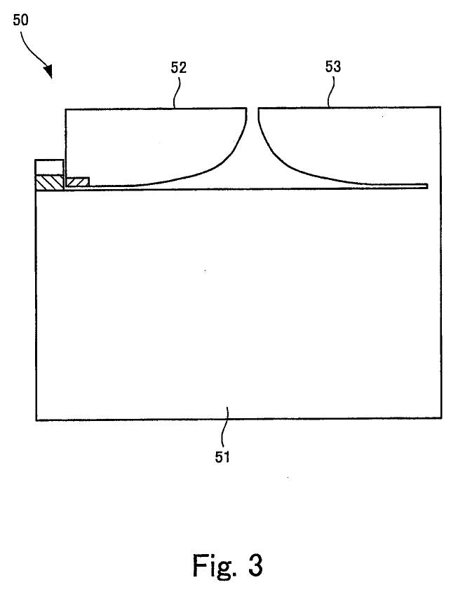

FIG. 3 shows a planar antenna 50 that is used as a comparative example to the planar antenna 10. As shown in FIG. 3, the planar antenna 50 comprises a ground plane 51, a main radiating element 52 and a parasitic element 53. The planar antenna 50 shown in FIG. 3 has a configuration similar to that of the planar antenna 10 shown in FIG. 1, except that the slits 131, 132 are not formed in the parasitic element 53 of the planar antenna 50.

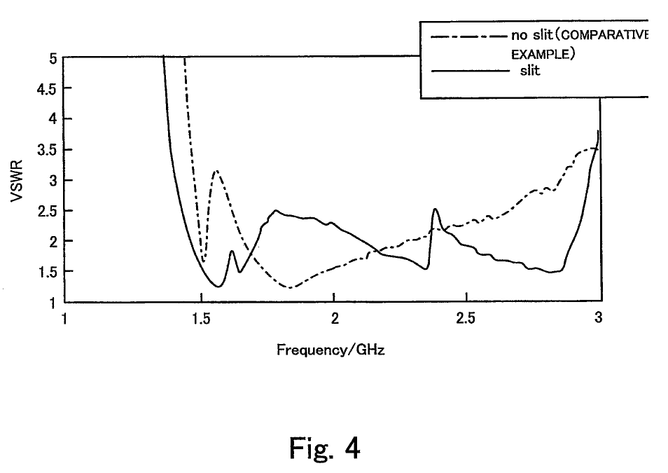

FIG. 4 is a graph comparing the measuring properties of the planar antenna 10 shown in FIG. 1 to the planar antenna 50 shown in FIG. 3. The planar antennas 10, 50 compared in the graph shown in FIG. 4 were each fabricated to have a width W1 of 60 mm, a height H1 of 50 mm, a width W2 of 65 mm, and a height H2 of 12 mm (dimensions only shown in FIG. 1). Additionally, each of the planar antennas 10, 50 was connected to a signal source to measure the properties thereof.

The horizontal axis of the graph shown in FIG. 4 indicates the frequency of signals fed from the signal source, and the vertical axis of the graph shown in FIG. 4 shows the voltage standing wave ratio (VSWR). As illustrated by the graph shown in FIG. 4, the planar antenna 50 shown in FIG. 3 has a resonating point around 1.8 GHz and has a favorable VSWR property around this frequency. However, the VSWR property of the planar antenna 50 shown in FIG. 3 gradually deteriorates, as the frequency of the signal increases from around 1.8 GHz. On the other hand, the planar antenna 10 shown in FIG. 1 has additional resonating points corresponding to the slits 131, 132. Thus, the VSWR is maintained in a certain range while repeating an increase and a decrease of its value, as the frequency of the signal rises. As a result, the band of the frequencies at which the VSWR is maintained at or below 2.8 is approximately 1.7 GHz to 2.7 GHz in the planar antenna 50 shown in FIG. 3. In contrast, in the planar antenna 10 shown in FIG. 1 in which the slits 131, 132 are formed, the VSWR is maintained at or below 2.8 throughout a wide frequency band exceeding one octave, from approximately 1.4 GHz to 2.9 GHz.

As described above, the planar antenna 10 according to the embodiment of the invention broadens the frequency band by including the main radiating element 12 and the parasitic element 13, which are shaped such that the space between the main radiating element 12 and the parasitic element 13 and the contact side 11a of the ground plane 11 is larger at a point where the main radiating element 12 and the parasitic element 13 are closer to each other. In addition, by providing the slits 131, 132 in the parasitic element 13, a favorable VSWR property is maintained in a wide frequency band exceeding one octave without needing to provide additional parasitic elements. Thus, a miniaturized planar antenna, which broadens the frequency band, is achieved.

The foregoing illustrates some of the possibilities for practicing the invention. Many other embodiments are possible within the scope and spirit of the invention. For example, although the sides 12a, 13a of the main radiating element 12 and the parasitic element 13 are described and shown herein as having an arc shape, the sides 12a, 13a of the main radiating element 12 and the parasitic element 13 may alternatively be substantially straight or stepped. Additionally, the overall shape of the main radiating element 12 and the parasitic element 13 are not limited to the shapes described herein. It is, therefore, intended that the foregoing description be regarded as illustrative rather than limiting, and that the scope of the invention is given by the appended claims together with their full range of equivalents.

What is claimed is:

1. A planar antenna, comprising:
a ground plane having a ground point;
a main radiating element having a feeding point positioned adjacent to the ground point, the main radiating element being positioned adjacent to a contact side of the ground plane such that a space is formed there between; and
a parasitic element positioned adjacent to the contact side of the ground plane such that a space is formed there between, the parasitic element being connected to the ground plane at a position farthest from the main radiating element, the parasitic element having at least one slit formed therein.

2. The planar antenna of claim 1, wherein the at least one slit extends substantially parallel to the contact side of the ground plane.

3. The planar antenna of claim 1, wherein the parasitic element has at least two slits of mutually different lengths.

4. The planar antenna of claim 1, wherein the planar antenna is formed in a surface of a flexible dielectric substrate.

5. The planar antenna of claim 1, wherein the planar antenna is formed within a single plane.

6. The planar antenna of claim 1, wherein the ground plane has a protruding section that substantially surrounds the feeding point of the main radiating element, the ground point being formed on the protruding section.

7. The planar antenna of claim 1, wherein the ground point contacts the contact side of the ground plane.

8. The planar antenna of claim 1, wherein main radiating element has a shape such that the space between the main radiating element and the contact side of the ground plane becomes larger as the main radiating element becomes closer to the parasitic element.

9. The planar antenna of claim 1, wherein the main radiating element is closest to the contact side in a position where the main radiating element is farthest from the parasitic element.

10. The planar antenna of claim 1, wherein the parasitic element has a shape such that the space between the parasitic element and the contact side becomes larger as the parasitic element becomes closer to the main radiating element.

11. The planar antenna of claim 1, wherein the parasitic element is closest to the contact side in a position where the parasitic element is farthest from the main radiating element.

12. A planar antenna, comprising:
a ground plane having a ground point;
a main radiating element having a feeding point positioned adjacent to the ground point, the main radiating element being positioned adjacent to a contact side of the ground plane such that a space is formed there between;
a parasitic element positioned adjacent to the contact side of the ground plane such that a space is formed there between; and
the main radiating element having a shape such that the space between the main radiating element and the contact side of the ground plane becomes larger as the main radiating element becomes closer to the parasitic element and the parasitic element having a shape such that the space between the parasitic element and the contact side becomes larger as the parasitic element becomes closer to the main radiating element.

13. The planar antenna of claim 12, wherein the planar antenna is formed in a surface of a flexible dielectric substrate.

14. The planar antenna of claim 12, wherein the planar antenna is formed within a single plane.

15. The planar antenna of claim 12, wherein the ground plane has a protruding section that substantially surrounds the feeding point of the main radiating element, the ground point being formed on the protruding section.

16. The planar antenna of claim 12, wherein the main radiating element has an arc shaped side facing an arc shaped side of the parasitic element.

17. The planar antenna of claim 12, wherein the parasitic element has at least one slit formed therein.

18. The planar antenna of claim 17, wherein the at least one slit extends substantially parallel to the contact side of the ground plane.

19. The planar antenna of claim 17, wherein the parasitic element has at least two slits of mutually different lengths.

20. The planar antenna of claim 17, wherein the parasitic element is connected to the ground plane at a position farthest from the main radiating element.
